(19) United States
(12) Patent Application Publication
(10) Pub. No.: US 2013/0185862 A1
(43) Pub. Date: Jul. 25, 2013

(54) MEDICAL GRADE PLASTIC COMPOSITION AND METHOD

(71) Applicants: Liza Ballen, Chicago, IL (US); Mary Gannon, Crystal Lake, IL (US)

(72) Inventors: Liza Ballen, Chicago, IL (US); Mary Gannon, Crystal Lake, IL (US)

(73) Assignee: Medline Ind, Mundelein, IL (US)

(21) Appl. No.: 13/355,173

(22) Filed: Jan. 20, 2012

(51) Int. Cl. A61G 9/00

(52) U.S. Cl. 4/450

(57) ABSTRACT

A medical article comprising pigment free plastic is disclosed. The plastic medical utensil comprises a pigment free plastic composition, wherein the plastic article has at least a translucent side wall.

The present disclosure relates generally to pigment free material for use plastics, in particular with medical utensils.

### BACKGROUND OF THE DISCLOSURE

A growing trend is to use post consumer recycled materials in the manufacture of new products. The reuse of this material results in less waste and is generally considered better for the environment. Products that currently reuse materials however are not medical grade and particularly, do not possess the strength characteristics to be used under certain medical situations.

Each time material is reprocessed, the material properties change affecting the quality of the reground material and particularly the impact strength of the final product. Many products such as bed pans and other patient aids and utensils using this material require significant strength and as a result are typically made with a high content of virgin plastic.

Additionally, the materials that are reprocessed often include colored material, which contains pigments. The pigments are not always the same and when mixed together present an unsightly look. Additionally, if the article is a pigment free article, the regrind material consequently results in the unwanted introduction of pigment to the article. However, pigment free plastics leave the contents of the medical utensils visible, which is particularly unattractive particularly for bed pans, urinals and the like that are filled with unsightly content. This can result in loss of patient or caregiver dignity. Many measurement markings use pigment or ink while others form miniature lines into the molded product of the same material which are difficult to read if not impossible.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is top orthogonal view of one embodiment of a translucent pigment free medical Utensil.

FIG. 2 is a side view thereof.

FIG. 3 is a partial view of one example of a measurement marking system of one embodiment.

FIG. 4 is a partial view of one example of a measurement marking system of another embodiment.

### DETAILED DESCRIPTION

Before describing in detail embodiments that are in accordance with the present invention, it should be observed that the embodiments reside primarily in combinations of apparatus components and method steps for a wound dressing. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In describing the embodiments of the invention in detail and referring to the drawings, like numbers indicate like parts throughout the figures. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

Embodiments of the invention provide a plastic composite comprising a mixture of a copolymer material, a homopolymer material and a non-virgin plastic material in one embedment. In another embodiment the plastic composite comprises a mixture of a copolymer, a homopolymer a non-virgin plastic component and a degradation additive. The impact strength of the plastic of these embodiments may be an important characteristic as the final product use dictates a higher level of necessary impact strength particularly in the medical utensil field.

In yet other embodiments, non-clarified, pigment free plastic material is provided to form a medical utensil that presents an attractive look while maintaining dignity to the patient or caregiver using the utensil, shielding unsightly waste such as urine, fecal matter and other bodily fluids. Even so, the transparency level of the plastic still allows for identification that material is present and that other foreign or indicating substances in the bodily waste material or present for diagnostic purposes. For example, blood in the stool, unusual bile, gross discolorations in fecal matter and urine and the like typically identified visually by care givers when using the utensils.

Medical utensils made of the composite virgin/non-virgin regrind resins include items such as, for example, basins including washbasins and emesis basins, bedpans, baths, carafes, pitchers, trays, and the like or any other plastic medical utensil. Basins need to be rigid enough so when filled completely with water it is easy to carry, however if too rigid it will be susceptible to cracking during shipment or use. As an example, In none embodiment, the product is run with a mixture of 50% homopolymer/50% copolymer. Bedpans: however are required to be rigid enough to take on the weight of a person without collapsing. As an example, in one embodiment, this product is run with 75% homopolymer and 25% copolymer. These compositions may also include pigment free resin, and may also include pigment free non-clarified plastic.

The injection molding process incurs a certain amount of scrap material from startup, shutdown, runners, and mold problems. Granulators or grinders in the manufacturing plant cut and shred up the non-conforming parts into granulate. This granulate is in flake form and varies in size according to the wall thickness of the part being granulated. This is commonly referred to as “regrind”.

As used herein, the term “regrind” means the diverse materials, including trim and non-compliant articles, which are typically ground up by conventional size reduction techniques and reused or otherwise recycled (e.g., in the process from which the regrind is generated or into some other process). In an embodiment the regrind is trim or scrap from a thermoforming or other technique involving molding, particularly blow molding. Typically, regrind material is the material reclaimed post processing from sprue, runners, flash, rejected parts or the like which is then ground or chopped into smaller pieces. Although the term “regrind” implies grinding of the material, it will be recognized by one of ordinary skill in the art that the scrap material can simply be thrown into a hopper and melted with the virgin resin according to the invention. The virgin resin may be added to the regrind in-line or it may be separately mixed with regrind, extruded into pellets, and then added to the forming operation making an article utilizing a regrind component.

In one embodiment a disposable medical article is made of material including plastic that comprises a first predetermined amount of virgin plastic and a first predetermined amount of reground plastic material. The reground plastic material comprises post manufactured plastic waste, also known as regrind. In one embodiment the size of the reground plastic is standard plastic pellet size as understood to one of ordinary skill in the art. The regrind is then combined with virgin resin to form the final resin to be used in the manufacturing process, molding, extruding or the like. The final resin may use a first generation reground material or subsequent generation reground material. A first generation reground material comprises material that has a percentage of regrind already present. Pigment free regrind may be collected separately from regrind material with dye and the pigment free subsequently mixed with virgin resin, which may be non-clarified, to create a pigment free article composition.

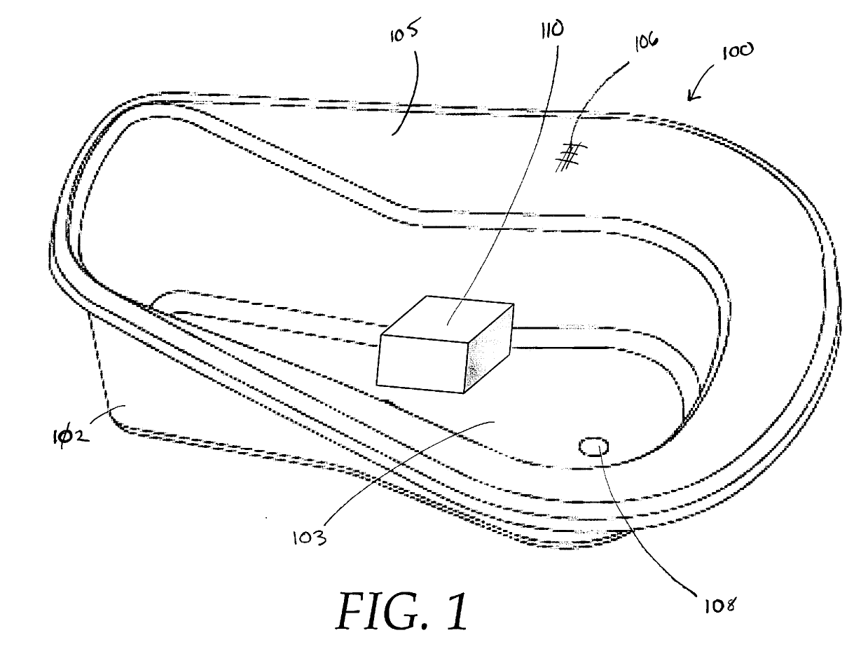

FIG. 1 illustrates a bed pan 100 made of pigment free plastic resin. It is to be understood that the bed pan 100 item is used only as an exemplary embodiment and the article may be any one of a plurality of medical utensil types that may be made of pigment free plastic. In this embodiment the side wall 102 of the bed pan 100 is made of non-clarified pigment free plastic. In particular in this embodiment, non-clarified polypropylene is used in at least construction of the side wall 102.

In this embodiment, the bed pan 100 has a plurality of side walls, and a bottom 103, coupled to the side walls 102 forming a container. The article may further include a top portion 105 coupled to the side wall. The top may also be a seat portion of the top portion. In one embodiment the top portion comprises a texture 106 formed on the surface of the seat portion which comes into contact with a user. A gate 108, formed from the molding process is shown.

The side wall 102 is translucent, obscuring the contents of the bed pan 100, though allowing light to travel through to identify to a user the presence of contents in the bed pan 100. The thickness of the side wall 100 is between 0.040 inches and 0.09 inches, and preferably 0.055 inches. The side wall 100 thickness may be about 0.055 and may vary, within manufacturing tolerances, as a result of the injection molding process, typically varying from thick to thin, as the distance from the gate increases. It is to be understood that other plastic material may be used such as polyethylene, PET, ABS, nylon, PVC, EVOH, and polycarbonates and the like, as known to those of ordinary skill in the art.

The translucency provides an esthetically pleasing look, a white cream while providing dignity to the user as the unsightly characteristics of the contents are not readily visible through the bed pan. This combination of esthetically pleasing looks, while hiding the unsightly content characteristics, is accomplished without the use of pigments or dyes.

The translucency is measured by luminosity, i.e. brightness. The translucent pigment free plastic has a diffusion characteristic, diffusing the light passing through the plastic so that the objects on the inside are not clearly visible. In one embodiment the non-clarified polypropylene diffuses the light as it passes through the plastic. In this embodiment, the combination of the non-clarified polypropylene and the side wall thickness between 0.040 inches and 0.09 inches creates a first translucency and further provides a wall thickness that supports a user of the bed pan.

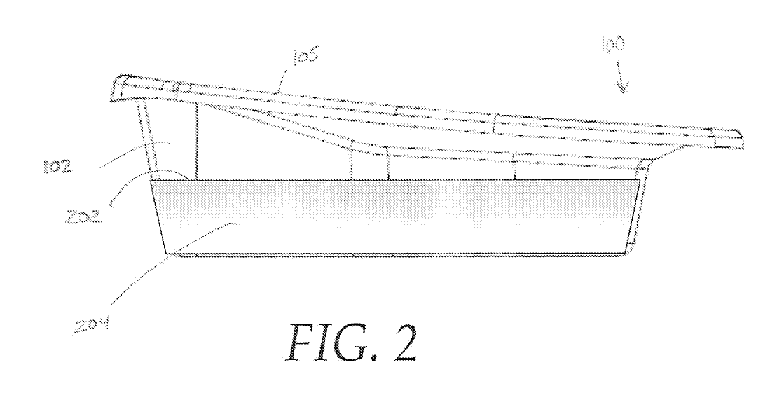

FIG. 2 illustrates one embodiment of a pigment free plastic article that is a bed pan 100, in a side plan view. An object 110 can be seen, looking in from the top view of FIG. 1 however, in combination with FIG. 2, the object is not seen in FIG. 2 through the side wall 102 and all that is visible in this side view is the liquid line 202 along the side wall of the contents 204. This is due to the opaqueness of the translucent pigment free polypropylene in this embodiment.

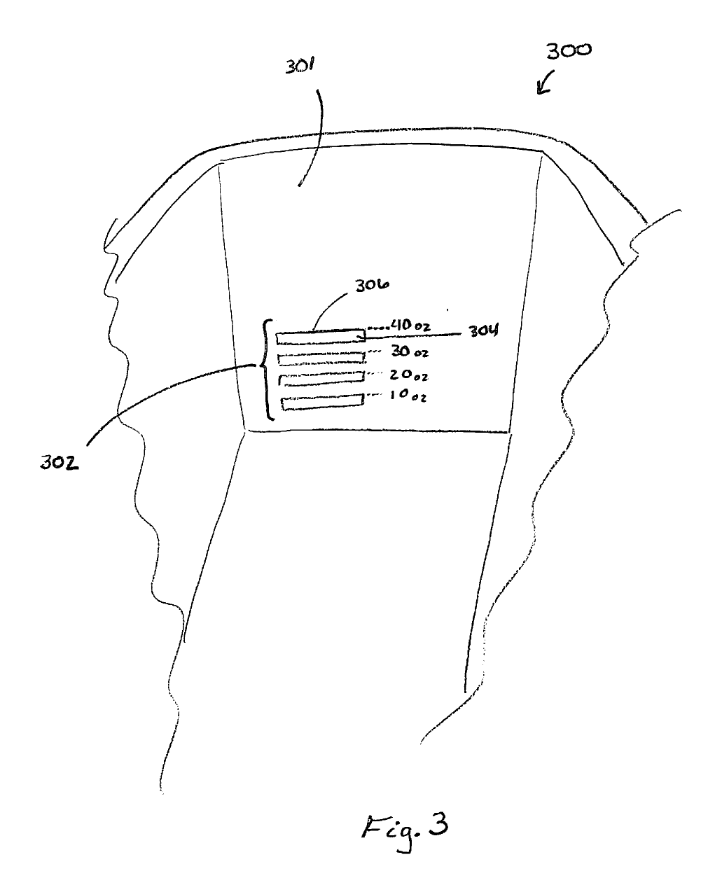

In one embodiment, illustrated in FIG. 3 a pigment free measurement gauge 302 is incorporated into the pigment free device for measuring the amount of contents present. Measurement indicators 304 are used to form the measurement gauge 302, and formed as part of the mold. In this embodiment, the indicators are transparent and stand out next to the translucent material adjacent to the transparent measurement line 304. The line 304 may have a width wider than the actual measurement, so as to form a measurement box 304, such that the measurement is indicated by the top line 306 of the measurement box 304. In another embodiment, the measurement box 304 is translucent, but has a thickness, greater than the side wall 301 thickness. The combination of the increased width and the increase thickness increase the visual distinction and improve the readability of the indicator marks.

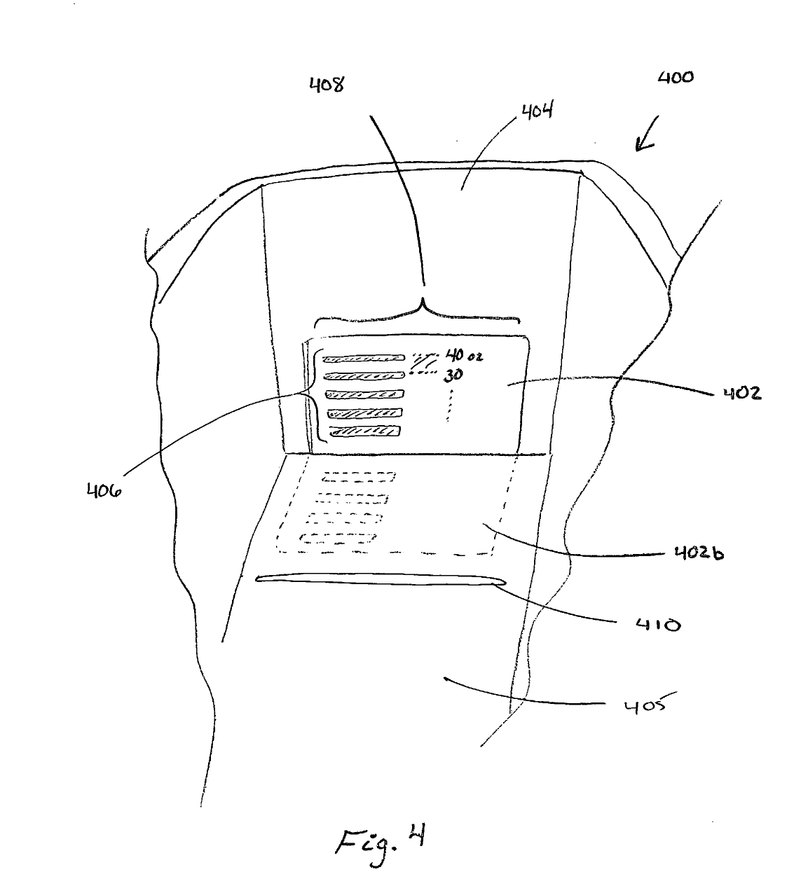

In another embodiment illustrated in FIG. 4, a clear transparent window 402 is positioned on a side wall 404 of the bed pan 400. Lines 406 of translucent plastic are aligned to make up the measurement gauge 408. Similar to embodiment of FIG. 3, the lines may be large, a form boxes, the top of the box forming the indicator line. Said another way, contents are measured by looking at the top line of the box, at the top line coincides with the measure amount. For Example, in FIG. 4, the Top of the line of the upper most box lines up with the 40 oz mark. Additionally, the actual amounts shown, 40 oz and 30 oz are merely exemplary and are not meant to be absolute as the amounts and units a by design choice.

In this embodiment the transparent window 402 is formed around the measurement gauge indicator lines to visually distinguish the line, increasing the readability. The transparent portion may be completely clear, and my be accomplished by a two shot type molding process or other molding process as understood to those of ordinary skill in the art. The transparent window 402 may be accomplished by polishing the plastic, leaving the indicator lines 406 unpolished.

In one alternative embodiment, a bottom measurement gauge 402b is on the bottom 405 of the article. Or in yet another embodiment, a content alignment marking 410 is disposed transversely across the bottom 405 of the article. The marking is used to align the edge of liquid content so that a coordinated opposite edge of the liquid content is measures on the measurement gauge 402. This is done when the contents of the article are minimal and taking an amount reading in the flat position is not possible. In one embodiment both measurement gauges are included in the article for measuring both small and larger amounts of fluid.

In one embodiment the plastic is pigment free, however, it is also clarified plastic, such as clarified polypropylene. The article is made translucent by roughening the surface, or adding a texture. The Roughened or textured surface may be incorporated into the mold or may be done by secondary operation.

In one embodiment, the medical article further comprises a degradation accelerator. The degradation accelerator accelerates the degrading of the material once disposed of. The biodegradable accelerator (also know as an enhancer) may be a chemical accelerator from EcoPure®, for example. EcoPure® is an additive that enhances the biodegradability of otherwise non-biodegradable plastic products through a series of chemical and biological processes when disposed of in a microbe-rich environment such as a biologically active landfill. EcoPure® additives are compatible with various types of plastics, including the following: PE, PET, PP, PS, Nylon, PVC, EVOH, and Polycarbonate. In one embodiment, for example, the additive comprises a chemo attractant compound, a glutaric acid or its derivative, a carboxylic acid compound with chain length from 5-18 carbons, a polymer; and a swelling agent.

In one embodiment the plastic composition is a pigment free plastic with a biodegradability additive. In another embodiment the plastic composition includes a pigment free plastic, regrind plastic and a biodegradability additive.

The strength of the article as measured by maximum load may be at least 140 pounds. The article may also exhibit a total energy between 0.9 and 6 foot-pounds. This is true for any of the embodiments as discussed above. In one particular embodiment the article is a bed pan that exhibits 140 pound maximum load and a total energy of about 1.5 foot-pounds.

In other embodiments, a medical article comprises an article formed of at least a first plastic comprising a non-clarified pigment free plastic, wherein at least a portion of a side wall of the article is translucent. The article may further include a bottom coupled to the side wall and a top portion coupled to the side wall. There may also be a seat portion of the top portion. In one embodiment the top portion comprises a texture formed on the surface of the seat portion which comes into contact with a user.

Some embodiments comprise a virgin plastic resin wherein a predetermined amount of a virgin plastic resin in the plastic is less than 90%. In other embodiment, the article comprises a virgin plastic resin wherein a predetermined amount of virgin plastic is less than 20%.

Some embodiments comprise a predetermined amount of reground clear plastic is greater than 75%. Other embodiments comprise a predetermined amount of reground clear plastic is between than 75% and 85%.

In these embodiment, the article may have a thickness of at least one wall of a structure of the material has a thickness between 0.01 inches and 0.09 inches and preferably about 0.055 inches.

A combination of homopolymer and copolymer propylene is used in order to achieve desired impact qualities. Homopolymer is rigid and copolymer is ductile. A product made completely from homopolymer will be too rigid and susceptible to cracking. A product made completely from copolymer will not be as susceptible to cracking, however will be susceptible to collapse.

Still another embodiment of a medical article comprises a plastic medical utensil comprising a pigment free plastic composition, wherein the plastic component has at least a translucent side wall. The article may further comprise an upper portion configured for positioning a patient to be seated on and wherein the upper portion is coupled to an supported by the at least one translucent side wall. In one embodiment the upper portion, may be pigment free. In these embodiments the pigment free plastic composition may be non-clarified plastic. In another embodiment, the pigment free plastic composition may be non-clarified polypropylene. In still yet another embodiment, the pigment free plastic composition may be a non-clarified plastic.

While the present disclosure and what the best modes of the inventions have been described in a manner establishing possession hereof by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A medical article comprising:
an article formed of at least a first plastic comprising a non-clarified pigment free plastic, wherein at least a portion of a side wall of the article is translucent.

2. The article of claim 1, further comprising a bottom coupled to the side wall and a top portion coupled to the side wall.

3. The article of claim 2, further comprising a seat portion of the top portion.

4. The article of claim 3, further comprising a texture formed on the surface of the seat portion which comes into contact with a user.

5. The medical article of claim 1, further comprising a degradation accelerator.

6. The article of claim 1, further comprising a virgin plastic resin wherein a predetermined amount of a virgin plastic resin in the plastic is less than 90%.

7. The article of claim 1, further comprising a virgin plastic resin wherein a predetermined amount of virgin plastic is less than 20%.

8. The article of claim 1, where the predetermined amount of reground clear plastic is greater than 75%.

9. The article of claim 1, where the predetermined amount of reground clear plastic is between than 75% and 85%.

11. The article of claim 1, wherein a thickness of at least one wall of a structure of the recycled material has a thickness between 0.01 inches and 0.09 inches and preferably about 0.055 inches.

12. A medical article comprising:
a moldable plastic material comprising less than 50% virgin plastic;
at least 50% reground plastic, the plastic substrate having total maximum load of at least 140 pounds.

13. The article of claim 12 further comprising a 80% regrind plastic and less than 20% virgin plastic.

14. The article of claims 12, further comprising a degradation additive.

15. A medical article comprising:
a plastic medical utensil comprising a pigment free plastic composition, wherein the plastic component has at least a translucent side wall.

16. The article of claim 15, further comprising a upper portion configured for positioning a patient to be seated on and wherein the upper portion is coupled to an supported by the at least one translucent side wall.

17. The article of claim 16, wherein the upper portion is also pigment free.

18. The article of claim 15, wherein the pigment free plastic composition is non-clarified plastic.

19. The article of claim 15, wherein the pigment free plastic composition is non-clarified polypropylene.

20. The article of claim 15, wherein the pigment free plastic composition is non-clarified plastic.
